(19) United States
(12) Patent Application Publication
(10) Pub. No.: US 2005/0117992 A1
(43) Pub. Date: Jun. 2, 2005

(54) Bolting device

(76) Inventor: Tor Evenrud, Borgen (NO)

Correspondence Address: CHRISTIAN D. ABEL, ONSAGERS AS, POSTBOKS 6963 ST. OLAVS PLASS, NORWAY, N-0130, NO

(21) Appl. No.: 10/994,399

(22) Filed: Nov. 23, 2004

Related U.S. Application Data
(60) Provisional application No. 60/524,647, filed on Nov. 25, 2003.

(51) Int. Cl. F16B 39/00

(52) U.S. Cl. 411/107

(57) ABSTRACT

A bolting device that overcomes the problem of thermal deformation of bolts as well as problems associated with the use of separated, elongated sleeves by providing a nut with an integrated, elongated sleeve. The nut according to the invention comprises an elongated nut having an internal bore and threads in its upper end, thus permitting the use of a flange bolt that is longer than the combined thickness of the materials that are bolted together. The novel formation of the internal bore and the relative dimensions of the nut function to prevent relaxation of the bolt tension that typically occurs with standard bolts when the materials are subject to thermal expansion and contraction.

This application clams the benefit of U.S. provisional patent application 60/524,647, filed 25 Nov., 2003.

### FIELD OF THE INVENTION

The present invention relates to nuts for flange bolts, in particular to nuts for flange bolts that are subject to thermal stretch.

### BACKGROUND AND SUMMARY OF THE INVENTION

It is a well known problem that bolts used to fasten materials that are exposed to high temperatures may be subject to stretching forces that often result in relaxation of bolt tension. The problem is associated with the fact that the materials often have a differential thermal growth compared to the bolt itself. The bolt is thus subject to stretching forces that can result in plastic deformation of the bolt.

One solution to this problem is to use an elongated bolt, such that the bolt shank is longer than the thickness of the materials being bolted together. Because less force is required to stretch a relatively thinner bolt, the stresses on the bolt will be less than if a bolt having a clamping length equal to the thickness of the bolted materials were used. The known solutions typically involve the use of a separate, elongated sleeve or spacer placed between the material and the nut. The use of such separate sleeves poses many well known problems and is thusly unsatisfactory in many applications.

The present invention overcomes the problem of thermal deformation of bolts as well as problems associated with the use of separated, elongated sleeves by providing a nut with an integrated, elongated sleeve. The nut according to the invention comprises an elongated nut having an internal bore and threads in its upper end, thus permitting the use of a flange bolt that is longer than the combined thickness of the materials that are bolted together. The novel formation of the internal bore and the relative dimensions of the nut function to prevent relaxation of the bolt tension that typically occurs with standard bolts when the materials are subject to thermal expansion and contraction.

### BRIEF DESCRIPTION OF THE DRAWINGS

The invention will be described in detail, with reference to the drawings, wherein:

FIG. 1 shows a first embodiment of the invention

FIG. 2 shows a second embodiment of the invention

FIG. 3 shows a third embodiment of the invention.

### DETAILED DESCRIPTION OF THE INVENTION

A slender bolt connection will have a reduced degree of material strain than a shorter bolt connection, since a given load is required to stretch a bolt by ΔL. By an increased bolt length, a reduced load will result in the same bolt ΔL. Accordingly, a slender bolt connection will be exposed to a reduced load when stretching the bolt ΔL, as opposed to a shorter bolt stretched to the same ΔL.

Stress increases in the bolt according to the invention is approximately 20% of the stress increase in a bolt with clamping length equal o the thickness of the flanges being bolted. As can be appreciated by the drawings, an essential aspect of the invention is that the length of bolt 16 is significantly greater than the thickness of the material being bolted together, here shown as plates 22.

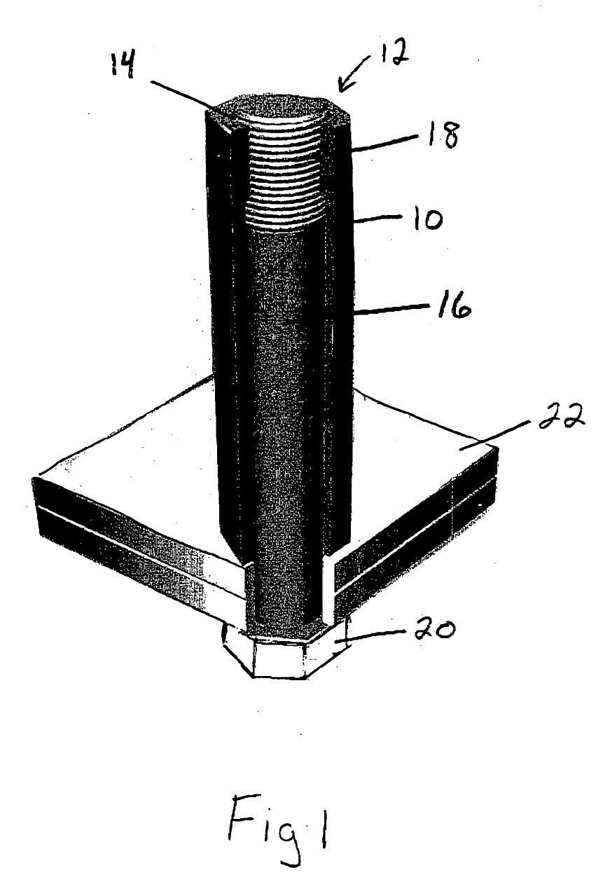

As can be appreciated from FIG. 1, one aspect the invention comprises a nut 10 in the form of an elongated sleeve with an internal cylindrical bore 12 and internal threads 14 in the upper end. This embodiment further comprises an elongated bolt 16 having corresponding threads 18 at its upper end. Nut 10 in this embodiment has a uniform cross section along its length, having a 6-sided outer surface suitable for manipulation by a tightening tool. The bolt 16 has a head 20 at one end.

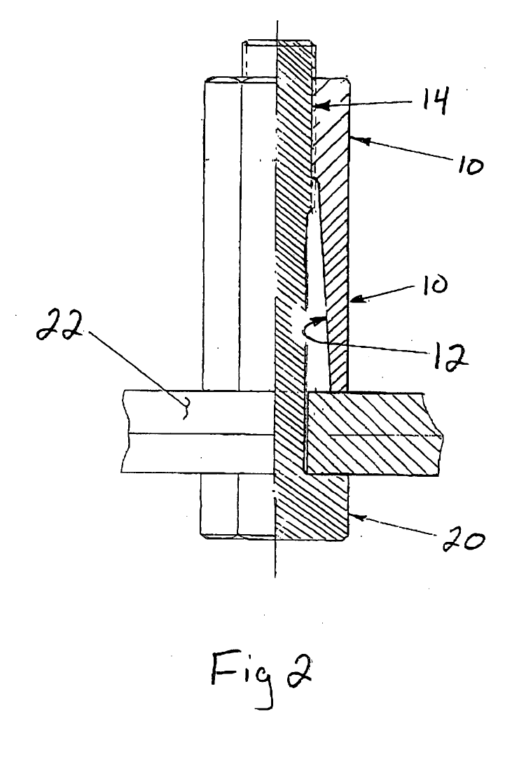

According to another aspect of the invention, illustrated in FIG. 2, the internal bore 12 is conical in shape, whereby the threaded end 14 has the smaller diameter, and whereby the cross sectional area of the elongated sleeve 10 at the upper, threaded end is greater than the bolt's 16 cross sectional area, and further whereby the cross sectional area of the elongated sleeve 10 at the lower end is less than the cross sectional are of the bolt 16.

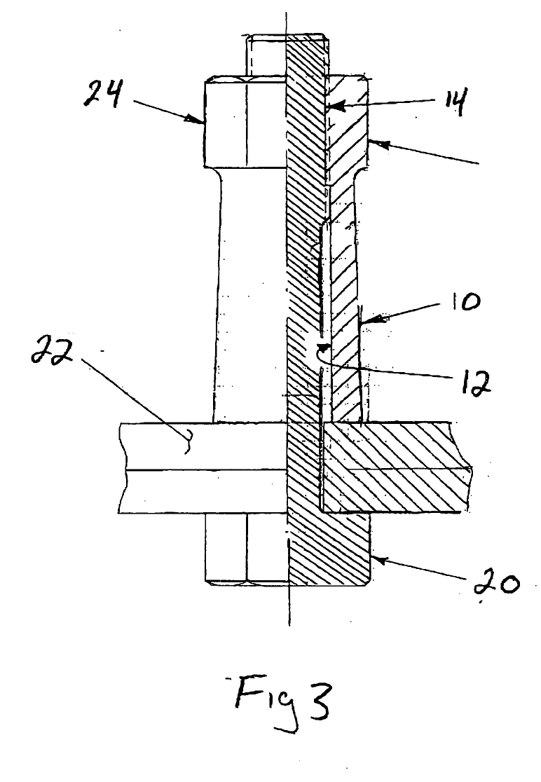

According to yet another aspect of the invention, illustrated in FIG. 3, the internal bore 12 is cylindrical, and the outer surface of the sleeve 10 is conical in shape, thus achieving the relative thicknesses as described above. In this embodiment, a 6-sided head 24 is provided at the threaded end of nut 10.

According to the preferred embodiment of the invention, the elongated sleeve 10 has a cylindrical bore and has the same, or even more preferably, a slightly greater cross sectional area than the shank of the bolt 16. According to this aspect of the invention, the elongated nut of the invention is designed with a cross sectional area that is equal to 1.03 times the cross sectional area of the bolt. This ensures that the stretch of the bolt is always greater than the (stretch) compression of the nut. In addition, the nut's washer face according to this aspect of the invention has the same area as the bolt's cross section. This is in order to avoid edge pressure and “flange face yield” when the bolt is exposed to an increase in pressure from heating of the bolted material.

According to yet another aspect of the invention, the bolt may be provided with a ceramic coating to avoid galvanic corrosion, and also to protect against heat radiation.

The nut and bolt according top the invention may be manufactured from any appropriate material known in the art, but are preferably constructed of materials wherein the nut has a thermal expansion coefficient that is the same or less than the material from which the bolt is contructed. Non-limiting examples of such materials incluse ASTM A193 grades B7, B8, B16, 422C, Grade 310, Inconel.

1. A bolting device, comprising an elongated nut 10 having an internal bore 12 with threads 14 located at the upper end, and an elongated flange bolt 16 having threads 18 at its upper end, wherein the length of nut 10 is significantly greater than the thickness of the material being bolted together 22.

2. The device according to claim 1, wherein the internal bore is cylindrical.

3. The device according to claim 2, wherein the outside surface of the nut is 6-sided, and bolt 16 has a 6-sided head.

4. The device according to claim 3, wherein the material from which nut 10 is constructed has a thermal expansion coefficient that is less than the material from which bolt 16 is constructed.

5. The device according to claim 3 or 4, wherein the nut 10 and bolt 16 are coated with a ceramic material.

6. The device according to claim 1, wherein the internal bore is conical, with the smaller diameter at the threaded end.

7. The device according to claim 1, wherein the outer surface of nut 10 is conical in shape, with the smaller diameter at the threaded end.
